(19) United States
(12) Patent Application Publication
(10) Pub. No.: US 2023/0266978 A1
(43) Pub. Date: Aug. 24, 2023

(54) NO-CODE METADATA-DRIVEN PROVISIONING OF GENERIC DOCUMENT SERVICE CONTROLS

(71) Applicant: SAP SE, Walldorf (DE)

(72) Inventors: Yan Zang, Singapore (SG); Sheng Yao, Singapore (SG)

(21) Appl. No.: 17/678,115

(22) Filed: Feb. 23, 2022

(51) Int. Cl. G06F 9/451

(52) U.S. Cl. CPC G06F 9/451

(57) ABSTRACT

Methods, systems, and computer-readable storage media for receiving, by a design-time environment of an application platform, user input representative of user selection of a document container as a UI element of a UI and values of one or more parameters of the document container, the document container including a generic document service control, storing first metadata representative of a construction of the UI and second metadata including logic of the UI, each of the first metadata and the second metadata automatically generated by the design-time environment based on the user input, and during production use of an application comprising the UI, determining, by a runtime of the application, that the UI comprises the generic document service control, and in response, by the runtime, instantiating a document service for storage of documents in one or more backend data stores.

### BACKGROUND

Users interact with computer-executed applications to perform a multitude of tasks. For example, in an enterprise setting, users can interact with one or more of an enterprise resource planning (ERP) application, a customer relationship management (CRM) application, and a human capital management (HCM) application to perform tasks in support of operations of an enterprise. To facilitate these interactions, applications are programmed with user interfaces (UIs), which can also be referred to as UI elements. Users interact with the application by providing input to and receiving output from UI elements. Example UI elements can include object pages, list pages, and analytics pages.

Applications are increasingly becoming cloud-based applications, which are executed within cloud platforms. For example, users interact with cloud-based applications through client-side UIs. In some examples, applications enable users to execute tasks as part of a workflow. In some instances, a task can require a user to attach, delete, and/or view one or more documents that are to be provided to the cloud-based application through a document service. For example, the document service enables communication between a client and a backend data store, within which the document is stored. Traditionally, creation and deployment of document services is a time- and resource-intensive task that is required to be performed by developers having comprehensive programming experience and skill in coding document services.

### SUMMARY

Implementations of the present disclosure are directed to automatic generation of generic document service controls. More particularly, implementations of the present disclosure are directed to a no-code, metadata-driven approach to automatically create generic document service controls as UI elements that enable users to attach, delete, and/or view documents stored in backend data stores.

In some implementations, actions include receiving, by a design-time environment of an application platform, user input representative of user selection of a document container as a UI element of a UI and values of one or more parameters of the document container, the document container including a generic document service control, storing first metadata representative of a construction of the UI and second metadata including logic of the UI, each of the first metadata and the second metadata automatically generated by the design-time environment based on the user input, and during production use of an application comprising the UI, determining, by a runtime of the application, that the UI comprises the generic document service control, and in response, by the runtime, instantiating a document service for storage of documents in one or more backend data stores.

These and other implementations can each optionally include one or more of the following features: actions further include creating an entity based on input to the UI during production use, storing at least one document in a backend data store through the document service, and associating the at least one document to the entity; the at least one document is stored in a folder that is converted from a temporary folder to an entity folder in response to user confirmation of creation of the entity; the second metadata includes a tag that is referenced in code for runtime integration of the UI in the application; the UI is provided as a web component during production use of the application; the UI is provisioned for user interaction with the application in execution of one or more tasks of a workflow; and the document service includes an open data protocol (OData) service.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example architecture in accordance with implementations of the present disclosure.

FIGS. 3A and 3B depict an example editor interface for no-code, metadata-driven development of generic document service widgets in accordance with implementations of the present disclosure.

FIGS. 4A and 4B depict an example generic document service control at runtime in accordance with implementations of the present disclosure.

FIG. 5 depicts an example process that can be executed in accordance with implementations of the present disclosure.

FIG. 6 is a schematic illustration of example computer systems that can be used to execute implementations of the present disclosure.

Like reference symbols in the various drawings indicate like elements.

### DETAILED DESCRIPTION

Implementations of the present disclosure are directed to automatic generation of generic document service controls. More particularly, implementations of the present disclosure are directed to a no-code, metadata-driven approach to automatically create generic document service controls as UI elements that enable users to attach, delete, and/or view documents stored in backend data stores.

Implementations can include actions of receiving, by a design-time environment of an application platform, user input representative of user selection of a document container as a UI element of a UI and values of one or more parameters of the document container, the document container including a generic document service control, storing first metadata representative of a construction of the UI and second metadata including logic of the UI, each of the first metadata and the second metadata automatically generated by the design-time environment based on the user input, and during production use of an application comprising the UI, determining, by a runtime of the application, that the UI comprises the generic document service control, and in response, by the runtime, instantiating a document service for storage of documents in one or more backend data stores.

To provide further context for implementations of the present disclosure, and as introduced above, users interact with computer-executed applications to perform a multitude of tasks. For example, in an enterprise setting, users can interact with one or more of an enterprise resource planning (ERP) application, a customer relationship management (CRM) application, and a human capital management (HCM) application to perform tasks in support of operations of an enterprise. To facilitate these interactions, applications are programmed with user interfaces (UIs), which can also be referred to as UI elements. Users interact with the application by providing input to and receiving output from UI elements. Example UI elements can include object pages, list pages, and analytics pages.

Applications are increasingly becoming cloud-based applications, which are executed within cloud platforms. For example, users interact with cloud-based applications through client-side UIs. In some examples, applications enable users to execute tasks as part of a workflow. In some instances, a task can require a user to attach, delete, and/or view one or more documents that are to be provided to the cloud-based application through a document service. For example, the document service enables communication between a client and a backend data store. An example document service can be provided as an Open Data Protocol (OData) service. The OData can be described as an open protocol that enables query-able and interoperable representational state transfer (REST) application programming interfaces (APIs) to be created and consumed. Using REST APIs, clients are able to publish and edit resources using hypertext transfer protocol (HTTP) messages. A resource can be defined within a data model and can be identified using a uniform resource indicator (URI).

Traditionally, creation and deployment of UIs that interact with OData services is a time- and resource-intensive task that is required to be performed by developers having comprehensive programming experience and skill in coding. This traditional requirement hinders the progress of developing and deploying cloud-based applications and is an inefficient use of technical resources (e.g., bandwidth, processors, memory). For example, development environments are provisioned on hardware to enable skilled developers to code and deploy applications with UIs that enable instantiation of and communication with OData services. Further, such development is executed in a development cycle that can include design, coding, testing, and deployment that can last days, if not weeks or even months.

In view of the above context, implementations of the present disclosure provide for automatic generation of generic document service controls within cloud platforms. In some implementations, the generic document service control of the present disclosure is implemented as a web component. In this manner, each generic document service control can be consumed by various web application development frameworks (e.g., UI5, React.js, Vue.js). As described in further detail herein, the generic document service control is generated using a no-code, metadata-driven approach.

As used herein, no-code refers to the absence of a dedicated developer and development environment to manually code UIs, which would then be tested and deployed over a development cycle (e.g., days, weeks). In some examples, a control can be provided as a widget, which can be described as a UI that enables a user to interact with an application. For example, a widget can display information and can include UI elements that enable a user to interact with an application. In general, a web component can be described as browser feature that provides a standard component model and can include custom elements (e.g., APIs to define hypertext markup language (HTML) elements), a shadow document object model (DOM) (e.g., encapsulated DOM and styling, with composition), and HTML templates. In accordance with implementations of the present disclosure, a UI element includes a document viewer that enables users to interact with (e.g., attach, delete, view) documents of any appropriate type (e.g., .pdf, .mp4, .txt, .png). Accordingly, the document viewer, and hence the generic document service control, is generic to types of documents that can be attached and/or accessed through the document viewer.

Implementations of the present disclosure provide one or more advantages. For example, implementations of the present disclosure provide a no-code, metadata driven approach that enables generic document service controls to be developed and deployed in a time- and resource-efficient manner. Further, implementations of the present disclosure obviate traditional code development phases, such as design, coding, and testing. As another example, by using a document service to store attached documents, the number of documents and/or the size of each document that can be attached are only limited by the amount of memory available for storage in a backend data store. Further, implementations of the present disclosure enable attached documents to be automatically stored in a nested folder structure.

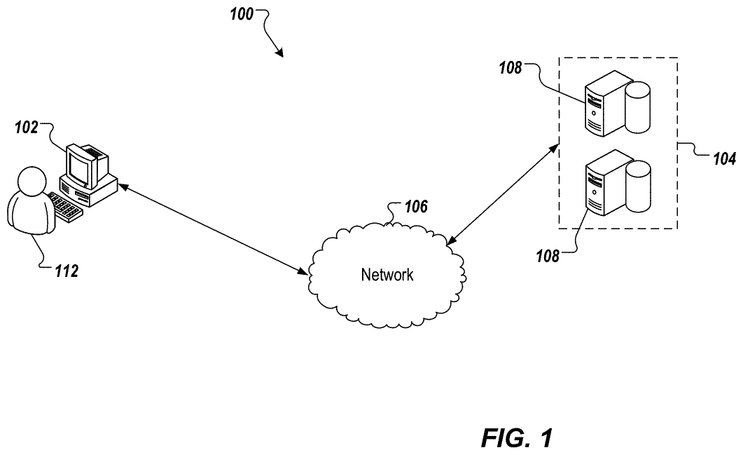

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106). In some examples, the server system 104 can provision a cloud platform that hosts one or more cloud-based applications.

In accordance with implementations of the present disclosure, the server system 104 can host an application platform for automatically generating generic document service controls, as described herein. In some examples, the generic document service controls are each provided as a web component and facilitate interaction between the user 112 and one or more cloud-based applications. For example, the user 112 can attach, delete, and/or view documents that support execution of workflow tasks through the cloud-based application(s), the documents being stored in a backend data store.

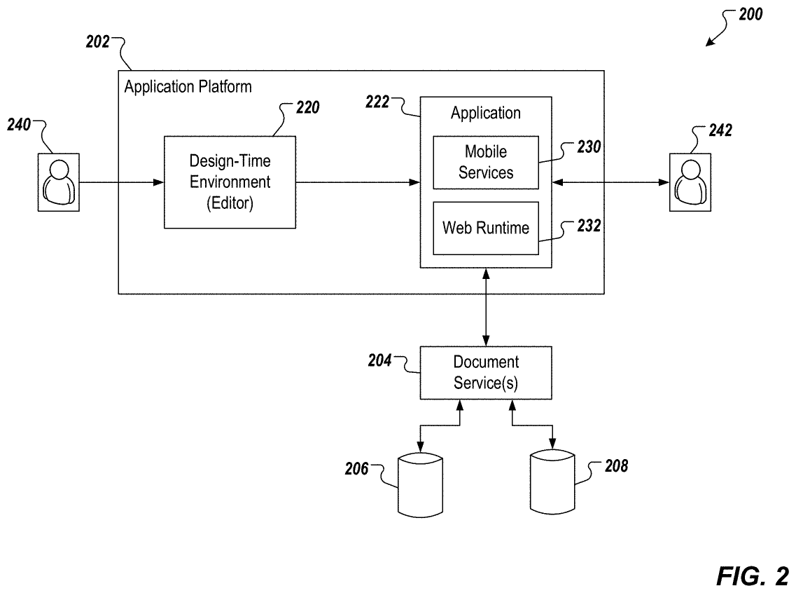

FIG. 2 depicts an example architecture 200 in accordance with implementations of the present disclosure. The example architecture 200 includes an application platform 202, a set of document services 204, and backend data stores 206, 208. In some examples, the backend data store 206 represents one or more enterprise-specific data stores. In some examples, the backend data store 208 represents one or more publicly accessible data stores (e.g., Internet-based data sources).

In general, the application platform 202 enables the development, deployment, and use of applications that enable users to execute workflow tasks in support of, for example, enterprise operations. An example application platform 202 includes the SAP Mobile Development Kit (MDK) provided by SAP SE of Walldorf, Germany. Although MDK is discussed herein for purposes of illustrating implementations of the present disclosure, implementations of the present disclosure can be realized using any appropriate application platform.

In the example of FIG. 2, the application platform 202 includes a design-time environment 220 and an application 222. The application 222 includes mobile services 230 and a web runtime 232. As described in further detail herein, the design-time environment 220 provides a web-based editor that enables users 240 to create applications, such as the application 222. In the context of MDK, the editor of the design-time environment 220 is provided as a SAP Business Application Studio space. In some examples, the mobile services (e.g., SAP Mobile Services) provide enterprise services that can include, but are not limited to, on-boarding, authentication, offline accessibility, and lifecycle management. In some examples, the web runtime 232 (e.g., MDK Web Runtime) is a runtime for the application 222. One or more end users 242 interact with the application 222 through a mobile client, which is provided as a native application that executes on a client device.

In some implementations, each document service 204 is provided as an OData service, through which the application 222 stores and/or accesses documents within one or more of the backend data stores 206, 208. As described in further detail herein, implementations of the present disclosure provide for no-code, metadata-driven development of generic document service controls for applications, such as the application 222, that enable the user(s) 242 to interact with (e.g., attach, delete, view) documents stored within one or more of the backend data stores 206, 208.

In further detail, the editor of the design-time environment 220 can be provided as a what-you-see-is-what-you-get (WYSIWYG) editor that enables visual-based development of applications. In accordance with implementations of the present disclosure, the editor can be used by users (e.g., the user 240) for no-code, metadata-driven development of generic document service controls, as described in further detail herein.

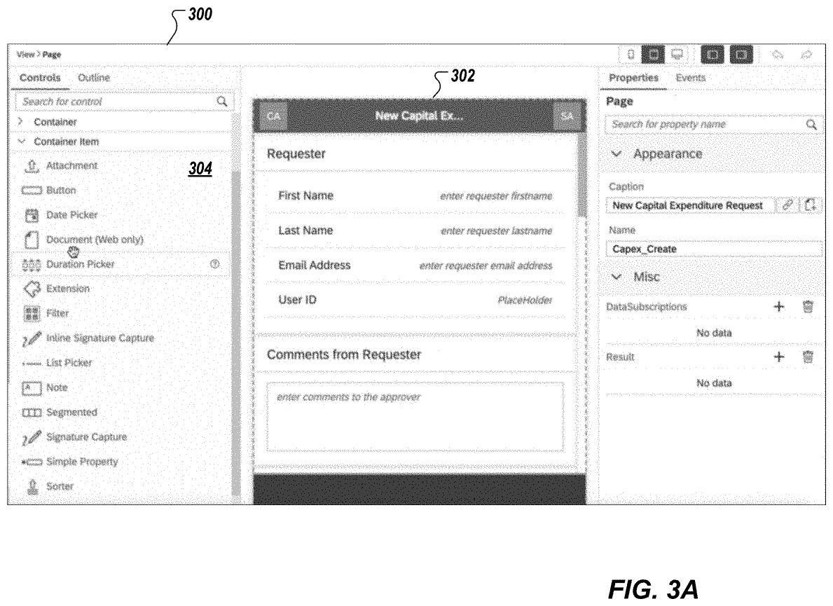

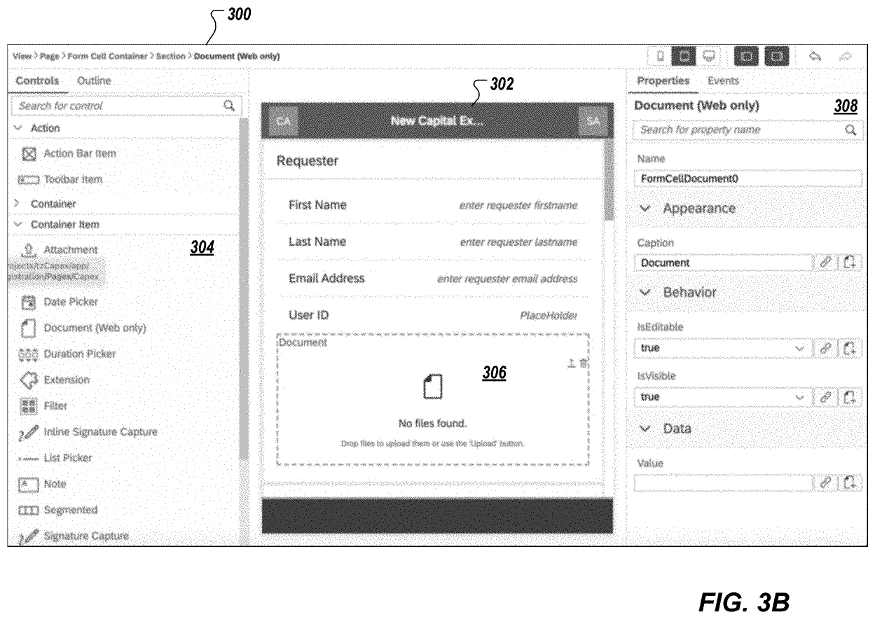

FIGS. 3A and 3B depict an example editor interface 300 for no-code, metadata-driven development of generic document service controls in accordance with implementations of the present disclosure. In the example of FIGS. 3A and 3B, an example UI 302 is being developed using an editor (e.g., the editor of the design-time environment 220 of FIG. 2). The editor interface 300 enables visual-based development in that a user (e.g., the user 240 of FIG. 2) can select items from one or more menus to include as elements of the UI 302. In the example of FIGS. 3A and 3B, the UI 302 is a new capital expenditure request form that enables users to submit information and documents that are relevant to a new capital expenditure request workflow.

The editor interface 300 includes a container item menu 304 that provides a list of container items that can be selected for inclusion in the UI 302. In accordance with implementations of the present disclosure, the container item menu 304, among other container items, includes a document container item. In some examples, the user can select (e.g., click on) the document container item and add the document container item to the UI 302 (e.g., by dragging and dropping). In response, the document container item is provided as a document viewer 306 within the UI 302, as depicted in FIG. 3B. As such, the UI 302 can be referred to as a generic document service control. That is, at runtime, the UI 302 enables users to attach any type of document to the new capital expenditure request, such that any attached documents are stored in a data store (e.g., the backend data store 206 of FIG. 2).

As depicted in FIG. 3B, the editor interface 300 displays a sub-interface 308 that enables the user to input parameter values for the document viewer 306. Example parameters can include, but are not limited to, name, appearance, behavior, and data. As the user interacts with the editor interface 300 to construct the UI 302 and define parameters of the document viewer 306, the editor automatically generates computer-readable code defining a UI construction and metadata-based logic of the UI 302.

For example, Listing 1, below, depicts an example UI construction of a UI (generic document service control) as a web component:

```
<div>
  <ui5-bar>
    <ui5-button ?hidden=“{{hideHomeButton}}” id=“btnHome”
icon=“home” design=“Transparent” title=“Go home”
slot=“startContent”></ui5-button>
    <ui5-label id=“title” slot=“middleContent”></ui5-label>
    <ui5-button
      hidden ?disabled=“{{readonly}}”
      id=“btnAddFolder” icon=“add-folder”
design=“Transparent” title=“Create Folder” slot=“endContent”>
    </ui5-button>
    <ui5-file-uploader id=“btnUploadFile” slot=“endContent”
hide-input ?disabled=“{{readonly}}”>
      <ui5-button ?disabled=“{{readonly}}” icon=“upload”
design=“Transparent”title=“Upload File”></ui5-button>
    </ui5-file-uploader>
    <ui5-button
      ?disabled=“{{readonly}}”
      id=“btnDelete” icon=“delete” design=“Transparent”
title=“Go to settings” slot=“endContent”>
    </ui5-button>
  </ui5-bar>
  <ui5-upload-collection mode=“None” id=“root” class=“list”
?no-dnd=“{{readonly}}”>
    <ui5-busyindicator style=“width: 100%” active
size=“Large”></ui5-busyindicator>
  </ui5-upload-collection>
  <ui5-dialog id=“dialog” header-text=“Document” stretch>
    <div slot=“footer” class=“dialog-footer”>
      <div style=“flex: 1;”></div>
      <ui5-button id=“btnClose”
design=“Emphasized”>Close</ui5-button>
    </div>
  </ui5-dialog>
</div>
```

### Listing 1: UI Construction of Generic Document Service Widget

As depicted in Listing 1, a header bar (ui5-bar) is provided, in which a buttons (ui5-button) are displayed (e.g., uploading documents, deleting documents), and a document viewer (ui5-upload-collection) is provided, which is used to view various types of documents within the UI (generic document service widget).

Listing 2, below, depicts example metadata-based logic of the UI (generic document service widget), as a web component:

```
Const metadata = {
  tag: “mdk-doc”,
  properties: {
  uniqueId: {
    type: String
  },
  readonly: {
    type: Boolean,
  },
  showHomeButton: {
    type: Boolean,
  }
  },
  slots: {
  },
  events: {
  rootFolderCreated: {
    detail: {
      item: { type: Object },
      uniqueId: { type: String }
    },
  },
  folderCreated: {
            detail: {
                  item: { type: Object },
      },
  },
  fileUploaded: {
          detail: {
                item: { type: Object },
        },
  },
  itemDeleted: {
        detail: {
              item: { type: Object },
        },
  },
  },
  }
```

### Listing 2: Example Metadata of Generic Document Service Control

As depicted in Listing 2, the metadata defines different parameters of the web component, such as tags, properties, and events. In the example of Listing 2, the tag mdk-doc is provided, which provides a unique identifier for the generic document service control.

In accordance with implementations of the present disclosure, after a UI is developed within the design-time environment, the UI is integrated into one or more applications (e.g., the application 222 of FIG. 2). In some examples, the UI is integrated based on the tag defined within the metadata-based logic. Listing 3, below, depicts integration of the UI (generic document service control), as a web component, with the runtime of the metadata-driven application development framework (e.g., MDK):

```
return (
    <div className={styles.formcell} hidden={this.isHidden ( ) }>
      <div id={this.props.params.data._Name}>
        <ui5-label>{this.state.caption}</ui5-label>
        <mdk-doc ref={ (elem: any) => this._dom = elem}
          id={this.props.params.data._Name}
          unique-id={this.props.params.data.Value}
          { . . . this.readOnly ( ) }
        />
      </div>
    </div>
  ) ;
}
```

### Listing 3: Runtime Integration

In the example of Listing 3, the tag mdk-doc is referenced to integrate the UI related to Listing 2 into the particular application runtime.

The so-developed application is deployed for runtime execution. For example, the application 222 is deployed within the application platform 202 to enable users 242 to interact with the application. In accordance with implementations of the present disclosure, the generic document service control is provided as a widget (UI element) within a UI. Listing 4, below, depicts example metadata of a generic document service control provided as a widget within a UI in the runtime of the metadata-driven application development framework (e.g., MDK):

```
{
    “$id”: “Page/FormCell/Document”,
    “title”: “Document”,
    “description”: “The Document control is a widget that
  display an SAP Document Service folder as an embedded
  element. \n In MDK 6.0 it's only available in Web Runtime,
  not in iOS and Android”,
    “properties”: {
      “Caption”: {
        “type”: “string”,
        “description”: “The key name of the property.”
      },
      “IsEditable”: {
        “type”: “boolean”,
        “description”: “Disables or enables document
  uploading/deleting.”,
        “default”: true
      },
      “IsVisible”: {
        “type”: “boolean”,
        “description”: “Sets the visibility of the control.”,
        “default”: true
      },
      “Value”: {
        “type”: “string”,
        “description”: “repositoryId, rootFolderId and
  objectId which link to a unique folder of document service.
  If leave empty a new folder will be created in document
  service instance.”
      },
      “_Name”: {
        “type”: “string”
      },
      “_Type”: {
        “const”: “Control.Type.FormCell.Document”
      }
    },
    “type”: “object”,
    “required”: [
      “_Type”,
    “_Name”
    ]
  }
```

### Listing 4: Metadata of Generic Document Service Control in Runtime

Listing 5, below, provides a metadata example of the generic document service control:

```
{
  “_Type”: “Page”,
  “_Name”: “FormCellsPage”,
  “Caption”: “FormCell Example”,
  “Controls”: [{
    “_Type”: “Control.Type.FormCellContainer”,
    “_Name”: “FormCellContainer”,
    “Sections”: [{
      “Caption”: “Update”,
      “Controls”: [{
        “_Type”: “Control.Type.FormCell.Document”,
        “_Name”: “Documentcell”,
        “Caption”: “Attachments”,
        “Value”: “{folder_id}”,
        “IsEditable”: true
      }]
    }]
  }]
{
```

### Listing 5: Metadata Example

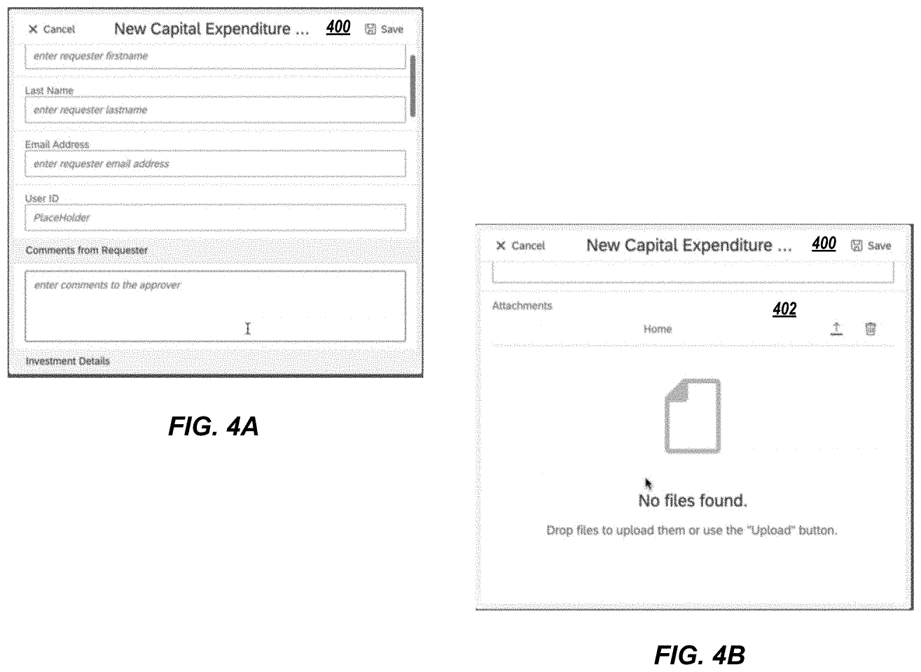

FIGS. 4A and 4B depict an example UI 400 including a generic document service control 402 at runtime in accordance with implementations of the present disclosure.

In some implementations, at runtime, the application creates an entity associated with the UI. In the non-limiting example of a new capital expenditure (capex) request, the application creates a capex entity and stores the capex entity within a data store (e.g., the backend data store 206 of FIG. 2). In some examples, the entity is provided as a data object that stores data associated with the entity (e.g., name, name of requestor, date). In some examples, the entity is assigned a unique entity identifier (e.g., objectId). If a user uploads documents through the generic document service control of the UI, the documents are also stored in a backend data store, separately from the entity. For example, and as depicted in Listing 4, the document service control defines a repository identifier (repositoryId) and a root folder identifier (rootFolderId), within which the document(s) is/are to be stored through a document service. The documents are associated with the entity based on the entity identifier. In this manner, the document(s) associated with the entity can be retrieved. For example, a requesting user can provide the documents as part of a new capex request and can submit the request. An approving user can retrieve the documents as part of an approval process and can approve/deny the new capex request.

In further detail, the runtime (e.g., the web runtime 232 of FIG. 2) automatically connects to the document service instance (e.g., a document service instance 204 of FIG. 2) and creates a document repository for the application. In some examples, this is done in response to the runtime detecting the generic document service control being used in the application (e.g., the application 222 of FIG. 2). For example, the generic document service control is implemented with a specific control type (e.g., “_Type”: “Control.Type.FormCell.Document”). In this manner, the runtime can determine whether the control type is present and, if so, determine that the generic document service control is being used. In accordance with implementations of the present disclosure, the runtime instantiates and configures a document service (OData instance) using document service metadata that is provided in an application project (e.g., MDK metadata project).

In some examples, a document service entity creation UI is displayed, and the runtime automatically creates a temporary folder for the entity in the document service instance. If the user cancels the creation, the temporary folder is automatically deleted. If the user confirms the creation, the runtime converts the temporary folder to an entity folder that is bound to the newly created entity.

In some implementations, multiple entities are created within a transaction (OData transaction). In such instances, if a transaction is committed, all of the temporary folders associated with all of the corresponding entities being created are converted to entity folders together. If the transaction is cancelled, all of the temporary folders are deleted together.

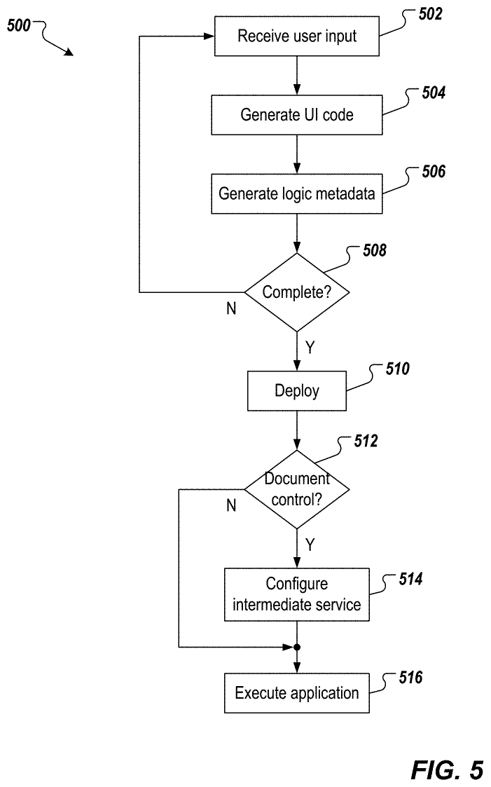

FIG. 5 depicts an example process 500 that can be executed in accordance with implementations of the present disclosure. In some examples, the example process 500 is provided using one or more computer-executable programs executed by one or more computing devices.

User input is received (502). For example, and as described herein, the user 240 provides input to the design-time environment 220 to define a UI. In some examples, the user input can include selection of items from one or more menus to include as elements of the UI as well as parameters associated with the UI and UI elements thereof (e.g., as described herein with reference to FIGS. 3A and 3B). UI code is generated (504). For example, and as described herein, the design-time environment 220 automatically generates metadata representative of the user input, such as the example UI construction of a UI (generic document service control), as a web component discussed herein with reference to Listing 1. Logic metadata is generated (506). For example, and as described herein, the design-time environment 220 automatically generates metadata representative of the user input, such as the example metadata-based logic of the UI (generic document service control), as a web component, discussed herein with reference to Listing 2.

It is determined whether development of the generic document service control is complete (508). For example, the user can provide input to the design-time environment indicating that design is complete (e.g., input saving). The application is deployed (510). For example, and as described herein, the application that uses the generic document service control is deployed for production use to enable users, such as users 242 to interact with the application and execute one or more workflow tasks. In some examples, deployment can include instantiation of the application including mobile services and runtime (e.g., the application 222, the mobile services 230, the web runtime 232) within the application platform (e.g., the application platform 202).

It is determined whether the application includes a document viewer (512). For example, and as described herein, the runtime of the application determines whether the application includes a document viewer (generic document service control). If the application includes a document viewer, a document service instance (intermediate service) is instantiated and configured (514). For example, and as described herein, the runtime of the application instantiates and configures the document service instance. The application is executed (516). For example, and as described herein, one or more users interact with the application using the document viewer (generic document service control) of a UI. In some examples, the user attaches one or more documents through the document viewer. In response, to the user committing an entity through the UI, the one or more documents are stored within a folder in the backend data store. Further, one or more entities (data objects) are generated and the one or more documents are associated with respective entities within the backend data store.

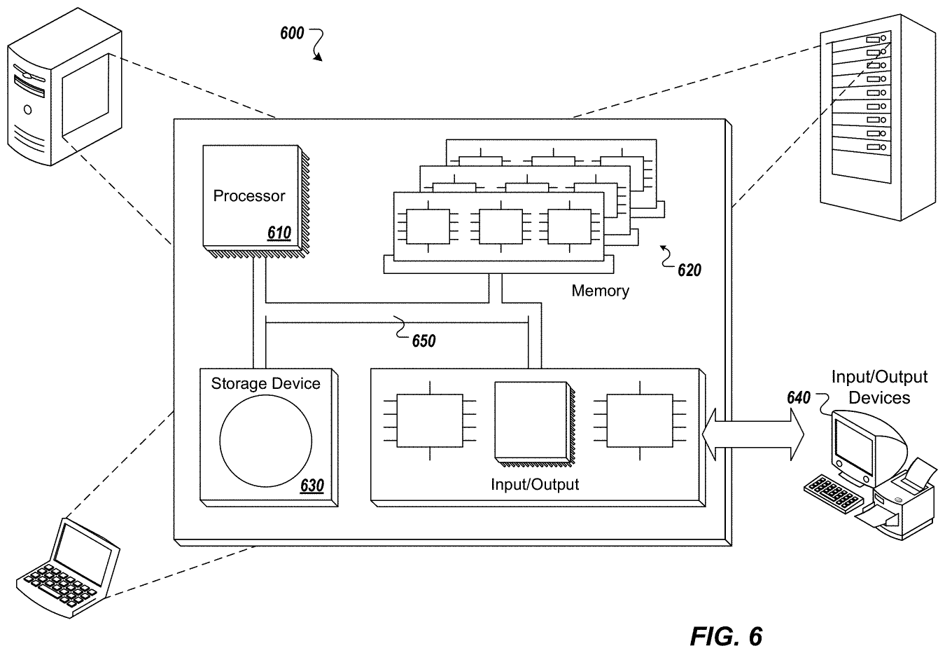

Referring now to FIG. 6, a schematic diagram of an example computing system 600 is provided. The system 600 can be used for the operations described in association with the implementations described herein. For example, the system 600 may be included in any or all of the server components discussed herein. The system 600 includes a processor 610, a memory 620, a storage device 630, and an input/output device 640. The components 610, 620, 630, 640 are interconnected using a system bus 650. The processor 610 is capable of processing instructions for execution within the system 600. In some implementations, the processor 610 is a single-threaded processor. In some implementations, the processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. In some implementations, the memory 620 is a volatile memory unit. In some implementations, the memory 620 is a non-volatile memory unit. The storage device 630 is capable of providing mass storage for the system 600. In some implementations, the storage device 630 is a computer-readable medium. In some implementations, the storage device 630 may be a floppy disk device, a hard disk device, an optical disk device, or a tape device. The input/output device 640 provides input/output operations for the system 600. In some implementations, the input/output device 640 includes a keyboard and/or pointing device. In some implementations, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a backend component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

1. A computer-implemented method for automatically providing generic document service controls in user interfaces (UIs) of applications, the method being executed by one or more processors and comprising:
receiving, by a design-time environment of an application platform, user input representative of user selection of a document container as a UI element of a UI and values of one or more parameters of the document container, the document container comprising a generic document service control;
storing first metadata representative of a construction of the UI and second metadata comprising logic of the UI, each of the first metadata and the second metadata automatically generated by the design-time environment based on the user input; and
during production use of an application comprising the UI, determining, by a runtime of the application, that the UI comprises the generic document service control based on a control type specified in application code of the application, and in response, automatically by the runtime:
instantiating a document service for storage of documents in one or more backend data stores, and
creating a document repository for the application.

2. The method of claim 1, further comprising:
creating an entity based on input to the UI during production use;
storing at least one document in a backend data store through the document service; and
associating the at least one document to the entity.

3. The method of claim 2, wherein the at least one document is stored in a folder that is converted from a temporary folder to an entity folder in response to user confirmation of creation of the entity.

4. The method of claim 1, wherein the second metadata comprises a tag that is referenced in code for runtime integration of the UI in the application.

5. The method of claim 1, wherein the UI is provided as a web component during production use of the application.

6. The method of claim 1, wherein the UI is provisioned for user interaction with the application in execution of one or more tasks of a workflow.

7. The method of claim 1, wherein the document service is provided using an open protocol that enables query-able and interoperable representational state transfer (REST) application programming interfaces (APIs) to be created and consumed.

8. A non-transitory computer-readable storage medium coupled to one or more processors and having instructions stored thereon which, when executed by the one or more processors, cause the one or more processors to perform operations for automatically providing generic document service controls in user interfaces (UIs) of cloud-based applications, the operations comprising:
receiving, by a design-time environment of an application platform, user input representative of user selection of a document container as a UI element of a UI and values of one or more parameters of the document container, the document container comprising a generic document service control;
storing first metadata representative of a construction of the UI and second metadata comprising logic of the UI, each of the first metadata and the second metadata automatically generated by the design-time environment based on the user input; and
during production use of an application comprising the UI, determining, by a runtime of the application, that the UI comprises the generic document service control based on a control type specified in application code of the application, and in response, automatically by the runtime:
instantiating a document service for storage of documents in one or more backend data stores, and
creating a document repository for the application.

9. The non-transitory computer-readable storage medium of claim 8, wherein operations further comprise:
creating an entity based on input to the UI during production use;
storing at least one document in a backend data store through the document service; and
associating the at least one document to the entity.

10. The non-transitory computer-readable storage medium of claim 9, wherein the at least one document is stored in a folder that is converted from a temporary folder to an entity folder in response to user confirmation of creation of the entity.

11. The non-transitory computer-readable storage medium of claim 8, wherein the second metadata comprises a tag that is referenced in code for runtime integration of the UI in the application.

12. The non-transitory computer-readable storage medium of claim 8, wherein the UI is provided as a web component during production use of the application.

13. The non-transitory computer-readable storage medium of claim 8, wherein the UI is provisioned for user interaction with the application in execution of one or more tasks of a workflow.

14. The non-transitory computer-readable storage medium of claim 8, wherein the document service comprises an open protocol that enables query-able and interoperable representational state transfer (REST) application programming interfaces (APIs) to be created and consumed.

15. A system, comprising:
a computing device; and
a computer-readable storage device coupled to the computing device and having instructions stored thereon which, when executed by the computing device, cause the computing device to perform operations for natural language explanations for automatically providing generic document service controls in user interfaces (UIs) of cloud-based applications, the operations comprising:
receiving, by a design-time environment of an application platform, user input representative of user selection of a document container as a UI element of a UI and values of one or more parameters of the document container, the document container comprising a generic document service control;
storing first metadata representative of a construction of the UI and second metadata comprising logic of the UI, each of the first metadata and the second metadata automatically generated by the design-time environment based on the user input; and
during production use of an application comprising the UI, determining, by a runtime of the application, that the UI comprises the generic document service control based on a control type specified in application code of the application, and in response, automatically by the runtime:
instantiating a document service for storage of documents in one or more backend data stores, and
creating a document repository for the application.

16. The system of claim 15, wherein operations further comprise:
creating an entity based on input to the UI during production use;
storing at least one document in a backend data store through the document service; and
associating the at least one document to the entity.

17. The system of claim 16, wherein the at least one document is stored in a folder that is converted from a temporary folder to an entity folder in response to user confirmation of creation of the entity.

18. The system of claim 15, wherein the second metadata comprises a tag that is referenced in code for runtime integration of the UI in the application.

19. The system of claim 15, wherein the UI is provided as a web component during production use of the application.

20. The system of claim 15, wherein the UI is provisioned for user interaction with the application in execution of one or more tasks of a workflow.
